(19) United States
(12) Patent Application Publication
(10) Pub. No.: US 2014/0075417 A1
(43) Pub. Date: Mar. 13, 2014

(54) Method and Arrangement for Enabling Analysis of a Computer Program Execution

(71) Applicant: Per Holmberg, Stockholm (SE)

(72) Inventor: Per Holmberg, Stockholm (SE)

(73) Assignee: TELEFONAKTIEBOLAGET L M ERICSSON (PUBL), Stockholm (SE)

(21) Appl. No.: 14/116,517

(22) PCT Filed: May 18, 2011
(86) PCT No.: PCT/EP2011/058044

§ 371 Date: Nov. 20, 2013

(51) Int. Cl. G06F 11/34

(52) U.S. Cl. CPC G06F 11/34
USPC 717/127

(57) ABSTRACT

Method and arrangement in a computer (200), for enabling analysis of a computer program execution. The method comprises limiting (205) a number of samples of an event, to be taken, and monitoring (206) the event when the computer program execution to be analysed is made. The method also comprises sampling (207) the monitored (206) event when it occurs, interrupting (209) the monitoring (206) of the event either when the limit of event samples has been reached, or a determined (202) maximum monitoring time has passed.

### TECHNICAL FIELD

The present disclosure relates to a method, an arrangement and a computer program. More in particular, it relates to a mechanism for enabling analysis of a computer program execution.

### BACKGROUND

Traditionally, profiling on hardware events may be made by sampling program profilers, which also may be referred to as event profilers, software profiler, execution profiler or sampling profiler, or just profiler, work by periodically interrupting program execution and collecting such as e.g. instruction address of the interrupted instruction, call stack etc. The characteristics are predictable and bound since the interrupts are periodic. That is, time for collecting a set of samples, such as e.g. 10 000, and the amount of data collected is defined by the sampling rate.

Current processors have hardware performance counters that may count events like cache misses, Translation Lookaside Buffer (TLB) misses and other high cost events, thereby investigating a program's behaviour using information gathered as the program executes. The latest generation of processors allow these counters to count from a start value and interrupt when reaching zero. That is, it is possible to do a similar sampling profiler for high cost events and see both the amount of events of each type, and also what part of the computer program that causes them, and/or what parts of the computer program that causes high cost events.

There are a few tools for profiling that has been extended to support profiling on hardware events, such as e.g. those mentioned above. However, these tools are primarily intended for software tuning of a single program on a desktop computer. That is, they do not take into account any of the problems of an embedded or real time system, i.e. to guarantee a bound CPU usage, to guarantee a limited memory usage, to guarantee a limited I/O bandwidth usage on a host-target connection, and to guarantee a Worst Case Execution Time (WCET) on high priority events.

Previously known event profiling uses hardware performance counters for generating interrupts on different types of hardware events, such as the above enumerated. However, there are only a few hardware performance counters available, typically less than the number of events types in the profiling.

To guarantee a Worst Case Execution Time (WCET) on high priority events is needed for hard real time system, while a telecom/datacom system usually may work with looser soft real time specification. The way to control the overhead is to sample every X event. However, there is a huge variation on how often different event types occur, ranging from almost every clock cycle to millions of clock cycles apart. Variations and order of magnitude may also depend on the dataset that program works on. Also, program execution may have phase behaviour with substantially different behaviour over time.

Thus it is hard to get the right amount of interrupts, i.e. a number of interrupts which is high enough to get reliable profiling data but still low enough for not disturbing the execution or overloading the communication.

The known tools provide, in best case, default values on event sampling rates. For example, some tools sets a default event sampling rate based on CPU type, CPU clock frequency and event type.

However, default values are a compromise since they does not account for software behaviour. Setting them conservatively enough to guarantee characteristics would give unusable result in the normal case and setting them less conservative may generate too high load or too much data.

Embedded systems have overheads and bottlenecks that do not exist in desktop or server computers and are not accounted for in the existing tools. For example, the overhead from protocol execution may be larger than the overhead from sampling itself and must be controlled. Also, the physical connection may have low bandwidth and there may be limited amount of memory for buffering collected data.

In addition, existing event profilers are limited for use in a lab environment, or for non-real time applications, which is a problem.

### SUMMARY

It is the object to obviate at least some of the above disadvantages and provide an improved mechanism for analysing computer program execution.

According to a first aspect, the object is achieved by a method in a computer for enabling analysis of a computer program execution. The method comprises limiting a number of samples of an event, to be taken. Also the method comprises monitoring the event when the computer program to be analysed is executed. Also, the method comprises sampling the monitored event when it occurs. Additionally, the method further comprises interrupting sampling/monitoring the event when the limit of event samples has been reached, or a determined maximum monitoring time has passed.

According to a second aspect, the object is also achieved by a computer program. The computer program aims at enabling analysis of a computer program execution, when it is executed by a processor in a computer. The computer program comprises computer program code for limiting a number of samples of an event to be taken, and monitoring the event when the computer program to be analysed is executed. Also, the computer program code comprises sampling the monitored event when it occurs. Additionally, the computer program code further comprises interrupting sampling/monitoring the event when the limit of event samples has been reached, or a determined maximum monitoring time has passed.

According to a third aspect, the object is also achieved by an arrangement in a computer for enabling analysis of a computer program execution. The arrangement comprises a processor. The processor is configured to limit a number of samples of an event, to be taken. In addition, the processor is configured to monitor the event when the computer program to be analysed is executed. Furthermore, the processor is also configured to sample the monitored event when it occurs. Additionally, the processor is furthermore configured to interrupt sampling/monitoring the event when the limit of event samples has been reached, or a determined maximum monitoring time has passed.

Thanks to embodiments of the herein disclosed methods, arrangements and computer programs, an event profiling with a predictable and bound characteristics is presented, enabling a tuning support that may be readily available at any arbitrary time period within the computer, or computer system. Embodiments of the herein disclosed methods, arrangements and computer programs, comprise a predictable behaviour rendering a predictable output such that it is rendered possible to collect profiling information at live sites. Also, in addition, embodiments of the herein disclosed methods, arrangements and computer programs, may be utilized with advantage when the hardware resources for buffering is limited, and or the number of hardware counters is limited.

Thereby is an improved mechanism for enabling analysis of a computer program execution within a computer achieved.

Other objects, advantages and novel features of the methods and arrangements will become apparent from the following detailed description.

### BRIEF DESCRIPTION OF THE DRAWINGS

The methods and arrangements will subsequently be described in more detail in relation to the enclosed drawings, in which:

FIG. 1A is a combined flow chart and block diagram illustrating an embodiment of the method.

FIG. 1B is a combined flow chart and block diagram illustrating an embodiment of the method.

FIG. 1C is a combined flow chart and block diagram illustrating an embodiment of the method.

FIG. 2 is a flow chart illustrating embodiments of method actions in a computer.

FIG. 3 is a block diagram illustrating embodiments of an arrangement in a computer.

### DETAILED DESCRIPTION

It is herein disclosed a method, a computer program and an arrangement in a in a computer for enabling analysis of a computer program execution, which may be put into practice in the embodiments described below. Those methods, computer programs and arrangements may, however, be embodied in many different forms and are not to be considered as limited to the embodiments set forth herein; rather, these embodiments are provided so that this disclosure will be thorough and complete.

Still other features and advantages of embodiments of the present methods, computer programs and arrangements may become apparent from the following detailed description considered in conjunction with the accompanying drawings. It is to be understood, however, that the drawings are designed solely for purposes of illustration and not as a definition of the limits of the present methods, computer programs and arrangements. It is further to be understood that the drawings are not necessarily drawn to scale and that, unless otherwise indicated, they are merely intended to conceptually illustrate the structures and procedures described herein.

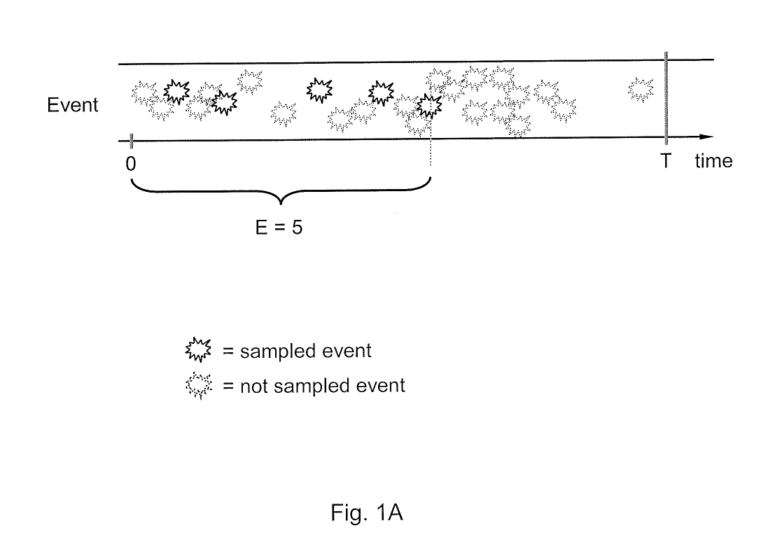

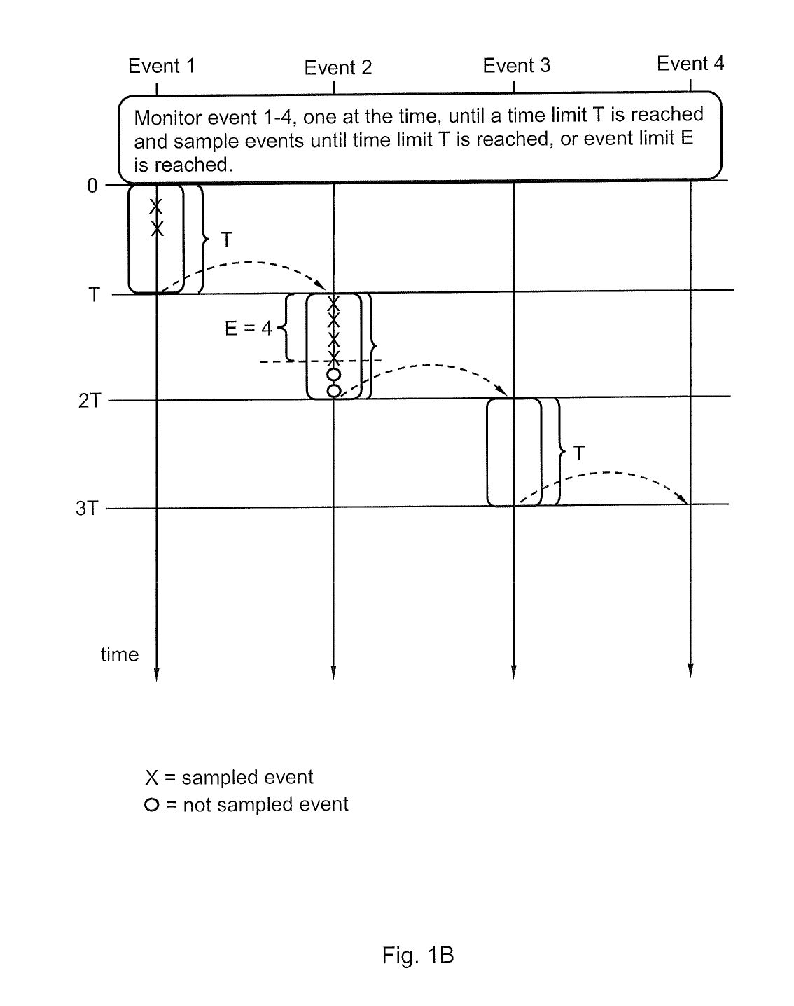

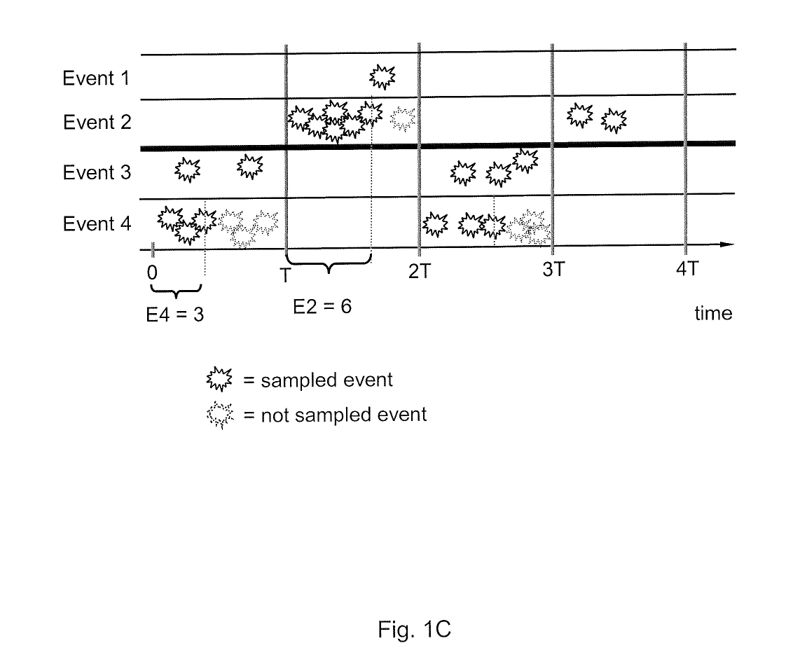

FIG. 1A is a schematic illustration over occurrences of an event over a period of time, according to some embodiments of the method.

The illustrated method is combining the aspects of time based sampling and event sampling. The events to be sampled may comprise one or more of e.g. cache miss, Translation Look-aside Buffer (TLB) miss, branch mis-predictions, stalls or memory fetches, and other events that may be costly for the computer program execution, according to some embodiments.

According to some embodiments, as illustrated in FIG. 1A, the event may be monitored and every n occurrence may be sampled until time limit T is reached, or until a limit of the number of sampled events, “E”, is reached. Thus the period n may be referred to as a sampling interval n. In the illustrated non-limiting example, n has been set to 3 and E has been set to 5. However, n as well as E may be set to any positive integer. However, normally, E is set to a bigger number than n.

Thus every third occurrence of the event may be sampled, until the time limit T, or the event count limit E is reached, whichever occurs first. Thereby it is possible to get a reasonable number of sampled events to analyse, while the covered period in time may be adjusted by changing the number n, according to some embodiments. If the number n is set too generously, i.e. such that too many samples are made in order to be convenient for analysis, the event limit E puts a limit on the number of made samples, unless the time limit T stops the sampling before, which may be the case, depending on how these parameters are selected and the number of occurring event.

Further, according to some embodiments, a hardware counter may be utilized in order to exclusively count the occurrences of the event. Thus, alternatively, a hardware counter may be dedicated only for that particular event, according to some embodiments.

FIG. 1B is a schematic illustration over some different events 1-4 over a period of time, according to some embodiments of the method.

The illustrated method is combining the aspects of time based sampling and event sampling for a plurality of events, here four events are monitored, as a non-limiting example. Alternatively may multiplexing and event sampling be separated and driving by different event streams, according to some embodiments.

According to some embodiments, as illustrated in FIG. 1B, the events 1-4 may be selected and sequentially monitored, one at the time, until a time limit T is reached and sample events until time limit T is reached, or event limit E is reached. The event limit E may be set individually for each event, according to some embodiments. In the illustrated scenario, event limit E=4 for the event 2. It is to be noted that every event is sampled, i.e. n is here set to 1.

It is further to be noted that when the event limit E=4 for the event 2 is reached, no more sampling is made, according to the illustrated embodiment, for that event. Thereby is an appropriate and yet representative amount of events sampled, while a selected plurality of events may be monitored and/or sampled.

The time-slice according to some embodiments of the method may be based on an asynchronous timer, which is not related to e.g. the execution of the program which is evaluated.

Further, according to some embodiments may a record of measurement time for each event type be kept and stored in a memory.

Thereby, embodiments of the method comprises combining time based sampling profiling with a maximum amount of data collected and a defined maximum number of samples per time unit. Thanks thereto, statistically correct or representative data may be given, while no starvation of uncommon event types are caused.

This is possible according to some embodiments by measuring periods randomly, uncorrelated to the execution of the program which is evaluated. Also, limitations are enforced individually per event type, even if multiple events may be sampled simultaneously by different hardware counters according to some embodiments as illustrated in FIG. 1C. Also, a record may be kept, for measuring the time per event type.

Further according to some embodiments, measurements may be multiplexed. Thereby multiple event types may be profiled at the same time, even with few hardware counters. Thus the same timeslot may be utilized for implementing multiplexing and to enforce limits on samples, according to some embodiments.

Further, according to some embodiments a limit on the data collected at each sample may be enforced. The call stack may be the only data with a dynamic size and the way to handle this may be to just allow a maximum depth.

FIG. 1C is a schematic illustration over some different events 1-4 over a period of time, according to some embodiments of the method.

According to some embodiments, as illustrated in FIG. 1C, the events 1-2 and 3-4, respectively, may be selected and sequentially monitored, two and two in parallel, until a time limit T is reached and sample events until time limit T is reached, or event limit E is reached. The event limit E may be set individually for each event, according to some embodiments. In the illustrated scenario, event limit E4=3 for the event 4 and event limit E3=6 for the event 3. Also in this example, n has been set to 1, such that every occurrence of each respective event may be sampled up to the limit E, or the time limit T, but this is merely an arbitrary example. Further, the sampling interval n may be set differently for different events, according to some embodiments.

It is to be noted that when the event limit E4=3 for the event 4 and event limit E3=6 for the event 3 respectively are reached, no more sampling are made, according to some embodiments for that respective event. Thereby is an appropriate and yet representative amount of events sampled, while a selected plurality of events may be monitored and/or sampled.

Embodiments of the method supports characteristics both in terms of execution overhead and both amount and rate of generated data. Thereby streaming of data to host may be enabled.

A non-limiting, but illustrative example of event sampling according to embodiments of the method will subsequently be discussed.

It may be desired to sample 50 K of 8 different types of events. 50 K may be expected to give accuracy needed not only to see hit ratios in general but also provide enough samples to locating the 3-4 hottest places in the computer program code to be analysed.

In total, it may be desired to sample about 400 K events in reasonable measurement time, like 1 minute. This corresponds to sampling 7 K events per second, which may be a reasonable sample rate that may not overload the system. Also, the amount of data to output from the system may also be reasonable, in the range of 2500 packets per second when assuming 100 words per sample and 1 Kbyte packets.

Changing the multiplexing e.g. 200 times per second may be enough for approximating a simultaneous measurement, according to some embodiments. If 3 separate multiplexing periods are assumed for measuring the 8 event types, then this may correspond to an average of 12 samples of each event in each multiplexing period it is active.

In this non-limiting example, the 8 events may be sampled, wherein a limit of taking maximum 5 samples of each type in each sampling period may be applied, and break after providing 500 K events or maximum 3 minutes, whichever occurs first.

During the measurement, the user interface may get updated every 3 seconds on how many samples that have been collected on each type. The user may directly see whether enough samples are collected for each type. If not then the user may break the measurement and change the value n for that event type.

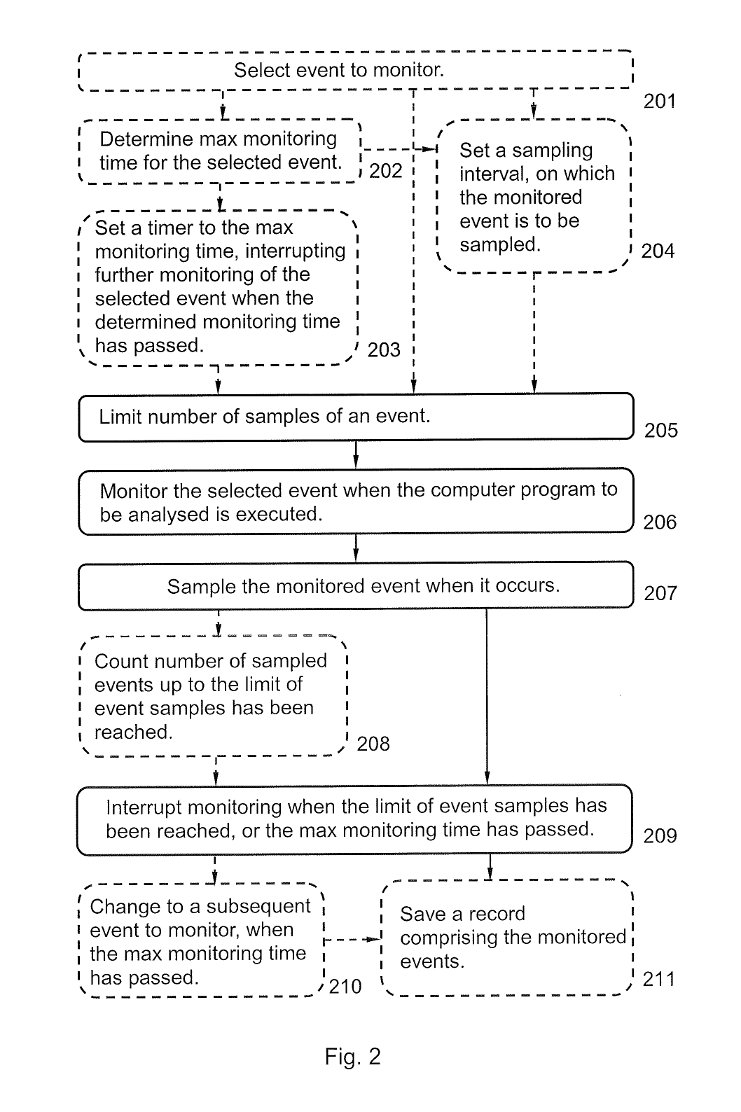

FIG. 2 is a schematic illustration over embodiments of method actions 201-211 performed in a computer. The method aims at enabling analysis of a computer program execution by using information gathered as the computer program execution to be analysed is made. The purpose of such analysis may be to determine which sections of the computer program/computer program execution to improve. Such improvement may comprise e.g. to increase the overall processing speed, decrease the memory usage etc. The computer program execution to be analysed may be referred to as the target program.

The method may comprise a periodic multiplexing which is driven by a separate clock cycle counter that counts down from a start value and generates an interrupt when reaching zero, according to some embodiments. The start value for the counter may be chosen to create periods that are asynchronous any periodicity in the execution.

Further, any sampling of individual events may be continuously made between multiplexing states by saving and restoring an event counter when being swapped out between multiplexing periods. In addition, a maximum number of each event may be sampled within a given multiplexing period. When reaching the maximum number of events to be sampled, the event may not be sampled/monitored until the scheduled again in a forthcoming multiplexing period. Also, there may be a counter summing up the number of clock cycles each event type has been monitored according to some embodiments. It may be possible to regard embodiments of the present method as a random sampling of events given that the start of the multiplexing with respect to the computer program execution. Saving and restoring of event counters according to some embodiments allows for correctly handling events that occur rarely. The counting of clock cycles may then be a correct estimate clock cycles between event samples.

To appropriately analysing the computer program, the method may comprise a number of method actions 201-211.

It is however to be noted that some of the described actions 201-211 are optional and only comprised within some embodiments, like e.g. action 201, 202, 203, 207, 209 and 211. Further, it is to be noted that the method steps 201-211 may be performed in any arbitrary chronological order and that some of them, e.g. action 201 and action 202, or a subgroup of the actions, or even all actions may be performed simultaneously or in an altered, arbitrarily rearranged, decomposed or even completely reversed chronological order. The method may comprise the following actions:

Action 201

This action may be performed within some additional embodiments, however, not necessarily within all embodiments of the method.

An event to monitor may be selected. According to some embodiments, a plurality of events to monitor sequentially may be selected. The number of events to monitor may be e.g. between 5 and 30, such as between 10-20 events, but it may be more than 30 events according to some embodiments.

The event or events to monitor may comprise one or more of e.g. cache miss, Translation Look-aside Buffer (TLB) miss, branch mis-predictions, stalls, memory fetches and/or any other high cost hardware events.

Action 202

This action may be performed within some additional embodiments, however, not necessarily within all embodiments of the method.

A maximum monitoring time, for monitoring the event up to the maximum monitoring time may be determined. The maximum monitoring time may be set to about e.g. a millisecond, 10 milliseconds, 100 milliseconds, or somewhere in between according to some embodiments.

In case a plurality of events are monitored, the maximum monitoring time may be set to the same value for all monitored events, or to different values for different events, according to different embodiments. Thus the determined maximum monitoring time may be adapted for each selected event of the plurality of events to monitor sequentially.

The maximum monitoring time limit is thus a time slot time, or a time limit, limiting the time during which each event may be monitored.

Action 203

This action may be performed within some additional embodiments, however, not necessarily within all embodiments of the method.

A timer may be set to the determined 202 maximum monitoring time. The timer may in turn be configured for interrupting further monitoring of the event when the determined 202 maximum monitoring time has passed, according to some embodiments.

Action 204

This action may be performed within some additional embodiments, however, not necessarily within all embodiments of the method.

A sampling interval n may be set, on which the monitored event is to be sampled when it occurs. The sampling of the monitored event may then be made on every n event when it occurs, where n is a configurable number.

Action 205

The number of samples to be taken of the event is limited.

According to some embodiments, the number of samples of the event, to be taken is limited per time period.

Furthermore, in case a plurality of events is monitored as may be the case according to some embodiments, the limit of event samples may be adapted for each selected event of the plurality of events to monitor sequentially.

Action 206

The event is monitored when the computer program execution to be analysed is made. Thus the event monitoring may start simultaneously with the beginning of the execution of the computer program to be analysed according to some embodiments.

Action 207

The monitored 206 event is sampled when it occurs.

Thereby, an interrupt may be generated e.g. by a timer, which interrupts the execution of the computer program to be analyzed. Then, interrupt routines may read, or sample, information that is relevant for the event type from processor registers and/or memory.

The information may then be saved/recorded in a memory. Thereafter, a return from the interrupt is made to resume the execution of the computer program to be analyzed.

Relevant information to be collected on the sampling may comprise any, some or all of e.g. event type, instruction address, i.e. where in the application code the event has occurred. The address may be a logical address, a virtual address, a real address and/or a physical address depending on e.g. processor type and/or operating system. Some other information that may be relevant for sampling, depending on event type, may be data address, i.e. for load/store instructions, jump/branch target, jump/branch prediction information, jump/branch conditions. It may also be relevant to collect data from the operating system and/or e.g. which program and/or process that is executed.

According to some embodiments, the sampling of the monitored 206 event when it occurs further may comprise to time stamp the sample, and/or to save the record comprising the monitored 206 event together with a time stamp.

To time stamp the event samples may improve the possibility to detect the phase behaviour in the output data stream according to some embodiments.

Thus a record comprising the monitored 206 event is saved. Further, the time that has passed when the limit of event samples has been reached may be comprised in the record, according to some embodiments.

In addition, the sampling of the monitored 206 event when it occurs further may comprise to sample every n event when it occurs, where n is a configurable number bigger than, or equal to 1. The configurable number n may be set to e.g. 1, 2, . . . , ∞; where ∞ is an infinite positive integer.

Action 208

This action may be performed within some additional embodiments, however, not necessarily within all embodiments of the method.

The number of sampled 207 events may be counted up to the limit of event samples has been reached. However, the number of sampled 207 events may according to some embodiments be counted down, starting at the limit of event samples, counting down to zero and then trigger an interruption of the sampling 207, according to some embodiments.

Action 209

The monitoring 206 of the event is interrupted when the limit of event samples has been reached, or a determined 202 maximum monitoring time has passed, according to some embodiments. Thereby is also the sampling 207 interrupted for that event.

Thus the monitoring of an event may be interrupted, or discontinued, when the limit of event samples has been reached, or the determined 202 maximum monitoring time has passed, according to some embodiments. Further, a change to another event to monitor may be made according to some embodiments.

Action 210

This action may be performed within some additional embodiments comprising a plurality of events to monitor 206, however, not necessarily within all embodiments of the method.

A change may be made to a subsequent event to monitor 206, of the plurality of events to monitor 206, when the determined 202 maximum monitoring time has passed.

Action 211

This action may be performed within some additional embodiments comprising a plurality of events to monitor 206, however, not necessarily within all embodiments of the method.

A record comprising the monitored 206 events may be saved. Further, the time that has passed when the limit of event samples has been reached, for each respective event, may be comprised in the record, according to some embodiments.

By saving the record of the sampled events, possibly together with e.g. the time that has passed when the limit of event samples has been reached and optionally a time stamp, later analysis of the computer program execution is facilitated, whereby e.g. hotspots in the computer program code may be detected.

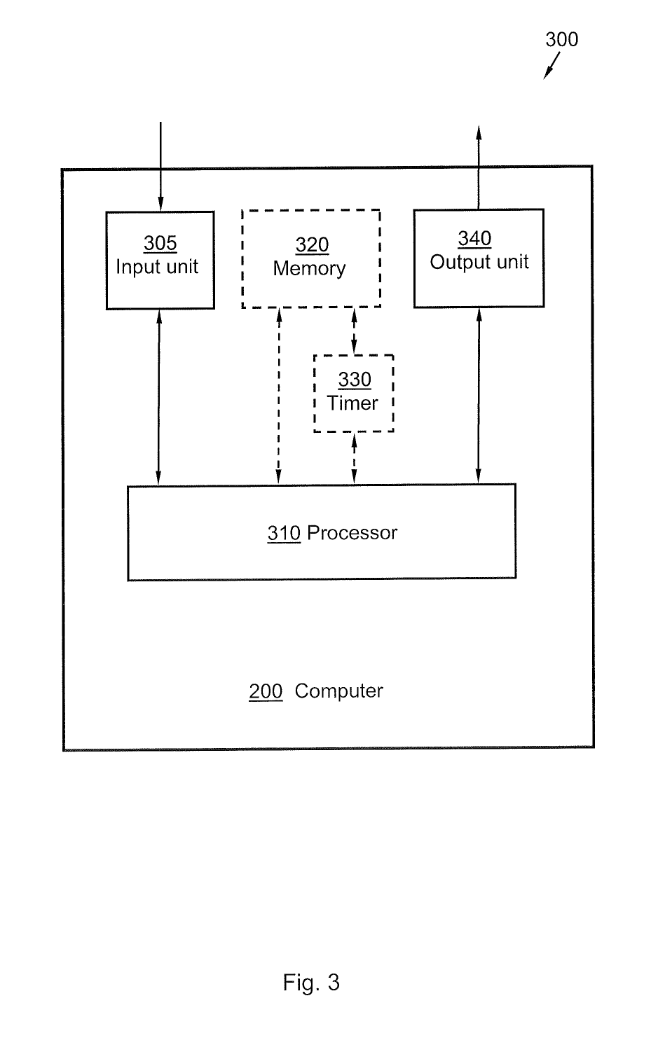

FIG. 3 is a block diagram illustrating embodiments of an arrangement 300, situated in a computer 200. The arrangement 300 is configured to perform any, some or all of the method steps 201-211 for analysing a computer program by using information gathered as the computer program to be analysed, executes.

For the sake of clarity, any internal electronics of the computer 200, not necessary for understanding the present solution has been omitted from FIG. 3.

In order to perform the actions 201-211 correctly, the arrangement 300 comprises a processor 310. Further, the processor 310 is also configured to limit a number of samples of the selected event, to be taken. Additionally, the processor 310 is furthermore configured, to monitor the selected event when the computer program execution to be analysed, is executed. The processor 310 is further also configured to sample the monitored event when it occurs. Also, the processor 310 is furthermore additionally configured to interrupt monitoring/sampling the event when the limit of event samples has been reached, or a determined maximum monitoring time has passed, and wherein, in addition, the processor 310 may further be configured to save a record comprising the monitored event.

The processor 310 may comprise e.g. one or more instances of a Central Processing Unit (CPU), a processing unit, a processing circuit, a processor, a microprocessor, or other processing logic that may interpret and execute instructions. The processor 310 may further perform data processing functions for inputting, outputting, and processing of data comprising data buffering and device control functions, such as call processing control, user interface control, or the like.

The processor 310 may furthermore be configured according to some embodiments, to select an event to monitor. Also, the processor 310 may be configured to determine a maximum monitoring time, for monitoring the selected event. Further, the processor 310 may further be configured to set a timer to the determined maximum monitoring time and interrupting further monitoring of the selected event when the determined maximum monitoring time has passed. Also, the processor 310 may further be configured to count the number of sampled events up to the limit of event samples has been reached. Additionally, the processor 310 may also be configured to save a record comprising the monitoring time of the event, i.e. the time for which the event has been monitored until the interruption occurred. Further according to some embodiments, the processor 310 may also be configured to save a record comprising the accumulated monitoring time of the event, i.e. the accumulated time for which the event has been monitored.

Additionally, the processor 310 may further be configured to select a plurality of events to monitor sequentially, and also configured to adapt the maximum monitoring time and the limit of event samples to the respective event. Further, the processor 310 may in addition be configured to change to a subsequent event to monitor, of the plurality of events to monitor, when the determined maximum monitoring time has passed.

The processor 310 may also be configured for recording active clock cycles for monitoring each event type, according to some embodiments. The counter may be configured for, when initiating a new profiling, set the counter to zero. When scheduled for of a new multiplexing period, the full time of the multiplexing period i.e. the start value of the multiplexing counter may be added according to some embodiments. Then the event may be enabled. Further, when the event occurs, a check may be performed, if a maximum number of events have occurred. If the maximum number of events has occurred, the current value of the multiplexing counter may be subtracted, according to some embodiments. The event may be disabled. The rate of events may then be calculated as the total number of times that an event has occurred divided with the number of active clock cycles, for example, according to some embodiments.

According to some embodiments, the arrangement 300 may comprise at least one memory 320. The memory 320 may comprise a physical device utilized to store data or programs i.e. sequences of instructions, on a temporary or permanent basis. According to some embodiments, the memory 320 may comprise integrated circuits consisting of silicon-based transistors. Further, the optional memory 320 may be volatile or non-volatile. The arrangement 300 may further according to some embodiments comprise at least one volatile memory 320 and also at least one non-volatile memory 320. Thus the memory 320 may comprise a non-transitory computer readable medium. The memory 320 may be configured to store a record comprising the monitored event and the monitoring time of that event, according to some embodiments. According to some embodiments, the memory 320 may be configured to store a record comprising the accumulated monitoring time of that event. The memory 320 may further be configured to store the determined maximum monitoring time for each respective event, according to some embodiments.

According to some embodiments, the arrangement 300 may also comprise a timer 330. The timer 330 may be configured to measure the monitoring time. Thus, the timer 330 may be set to a predetermined time value, i.e. the maximum monitoring time. Thereafter, when the predetermined time, i.e. maximum monitoring time has passed, a switch may be made to another event to be monitored, according to some embodiments. Thus the timer 330 may be configured to measure the monitoring time of the event, up to the maximum monitoring time for the event.

Additionally, the arrangement 300 may comprise according to some embodiments, an output unit 340, configured to output data such as e.g. the sampled events and stored record. The arrangement 300 may furthermore comprise an input unit 305, configured to input data to be processed according to some embodiments.

The arrangement 300 may comprise according to some embodiments, one or more hardware counters, or hardware performance counters. These hardware counters may comprise a set of special-purpose registers built into the processor 310 to store the counts of hardware-related activities within the arrangement 300. Thereby a low-level performance analysis or tuning may be performed, according to some embodiments.

It is to be noted that the described units 305-340 comprised within the arrangement 300 may be regarded as separate logical entities, but not with necessity as separate physical entities. Any, some or all of the units 305-340 may be comprised or co-arranged within the same physical unit. However, in order to facilitate the understanding of the functionality of the arrangement 300 in the computer 200, the comprised units 305-340 are illustrated as separate units in FIG. 3.

The method actions 201-211 in the arrangement 300 comprised in the computer 200 may be implemented through one or more processors 310, together with computer program code configured to perform the functions of the present method actions 201-211, when executed by the processor 310. Thus a computer program product, comprising instructions for performing the method actions 201-211 in the computer 200 may be configured for analysing the computer program execution.

The computer program product mentioned above may be provided for instance in the form of a data carrier carrying computer program code for performing the method steps according to the present solution when being loaded into the processor 310. The data carrier may be e.g. a hard disk, a CD ROM disc, a memory stick, an optical storage device, a magnetic storage device or any other appropriate non-transitory computer readable medium such as a disk or tape that can hold machine readable data. The computer program code may furthermore be provided as program code on a server and downloaded to the processor 310 remotely, e.g. over an Internet or an intranet connection.

The present methods and arrangements may be embodied as a method, an arrangement 300 in a computer 200, and/or computer program products. Accordingly, the present methods and arrangements may take the form of an entirely hardware embodiment, a software embodiment or an embodiment combining software and hardware aspects all generally referred to herein as a “circuit”. Furthermore, the present methods and arrangements may take the form of a computer program product on a computer-usable non-transitory storage medium having computer-usable program code embodied in the medium. Any suitable computer readable medium may be utilized comprising hard disks, CD-ROMs, optical storage devices, a transmission media such as those supporting the Internet or an intranet, or magnetic storage devices etc.

The terminology used in the detailed description of the particular exemplary embodiments illustrated in the accompanying drawings is not intended to be limiting of the methods and arrangements herein described.

As used herein, the singular forms “a”, “an” and “the” are intended to comprise the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

1-15. (canceled)

16. A method in a computer for enabling analysis of a computer program execution, the method comprising:
limiting a number of samples of an event to be taken;
monitoring the event when the computer program to be analyzed is executed;
sampling the monitored event when it occurs;
interrupting monitoring the event in response to the limit of event samples being reached.

17. The method of claim 16, further comprising:
determining a maximum monitoring time for the event;
setting a timer to the maximum monitoring time;
interrupting monitoring the event before the limit of event samples has been reached in response to the determined maximum monitoring time having passed.

18. The method of claim 17, further comprising:
selecting the event and at least one additional event;
adapting, for each selected event, the determined maximum monitoring time and the limit of event samples;
choosing a start value for the timer to create periods that are asynchronous with any periodicity in the computer program execution;
monitoring the events sequentially;
changing to a subsequent event to monitor, of the selected events, in response to the determined maximum monitoring time having passed;
saving a record comprising the monitored events.

19. The method of claim 16, further comprising selecting the event.

20. The method of claim 16, further comprising setting a sampling interval at which the event is to be sampled.

21. The method of claim 16, wherein the number of samples of the event to be taken is limited for a time period.

22. The method of claim 16, further comprising counting the number of sampled events until the limit of event samples has been reached.

23. The method of claim 16, wherein sampling the monitored event when it occurs comprises time stamping the sample.

24. The method of claim 16, wherein the event comprises one of:
a cache miss;
a Translation Look-aside Buffer miss;
a branch misprediction;
a stall;
a memory fetch.

25. A computer program product stored in a non-transitory computer readable medium for controlling a computer, the computer program product comprising software instructions which, when executed on the computer, causes the computer to:
limit a number of samples of an event to be taken;
monitor the event when a computer program to be analyzed is executed;
sample the monitored event when it occurs;
determine a maximum monitoring time for the event;
set a timer to the maximum monitoring time; and
interrupt monitoring the event in response to at least one of:
the limit of event samples being reached;
the determined maximum monitoring time having passed.

26. An arrangement in a computer for enabling analysis of a computer program execution, the arrangement comprising:
a processor configured to:
limit a number of samples of an event to be taken;
monitor the event when the computer program to be analyzed is executed;
sample the monitored event when it occurs;
interrupt monitoring the event in response to the limit of event samples being reached.

27. The arrangement of claim 26, wherein the processor is further configured to:
determine a maximum monitoring time for the event;
set a timer to the maximum monitoring time; and
interrupt monitoring the event before the limit of event samples has been reached in response to the determined maximum monitoring time having passed.

28. The arrangement of claim 27, wherein the processor is further configured to:
select the event and at least one additional event;
adapt, for each selected event, the maximum monitoring time and the limit of event samples;
monitor the events sequentially;
change to a subsequent event to monitor, of the selected events, in response to the determined maximum monitoring time having passed.

29. The arrangement of claim 28, wherein the processor is further configured to choose a start value for the timer to create periods that are asynchronous with any periodicity in the computer program execution.

30. The arrangement of claim 26, wherein the processor is further configured to select the event.

31. The arrangement of claim 26, wherein the processor is further configured to count the number of sampled events until the limit of event samples has been reached.

32. The arrangement of claim 26, further comprising memory configured to store a record comprising the monitored event and the monitoring time of that event.

33. The arrangement of claim 26, further comprising a timer configured to measure the monitoring time of the event, up to a maximum monitoring time for the event.
